(19) United States
(12) Patent Application Publication
(10) Pub. No.: US 2022/0143513 A1
(43) Pub. Date: May 12, 2022

(54) SEQUENTIALLY ORDERED GAMING SYSTEM FOR SOLVING A MYSTERY

(71) Applicants: John Carroll, South Miami, FL (US); Jason Wilson, South Miami, FL (US)

(72) Inventors: John Carroll, South Miami, FL (US); Jason Wilson, South Miami, FL (US)

(21) Appl. No.: 17/093,043

(22) Filed: Nov. 9, 2020

(51) Int. Cl. A63F 13/822; A63F 9/18; A63F 13/69; A63F 13/5375

(52) U.S. Cl. CPC A63F 13/822; A63F 9/18; A63F 13/69; A63F 2300/807; A63F 2300/305; A63F 2300/609; A63F 13/5375

(57) ABSTRACT

A sequentially ordered gaming system, kit, or method that allows users to solve a mystery is disclosed, comprising a first objective and a physical package with evidence that enables a user to complete the first objective. A first envelope or other enclosure has a second objective and additional evidence necessary for completion of the second objective, and a second enclosure has a third objective and additional evidence necessary for completion of the third objective. A remote confirmation source is accessed by the user to input specific evidence-related information to determine completion of the objectives and to receive hints. Completion of the first, second, and third objectives in order solves the mystery. The enclosures are typically physical enclosures that are sealed to keep their evidence concealed until use. A final enclosure tells the story of the solved mystery. Evidence includes a combination of a wide variety of materials.

### RELATED APPLICATIONS

This application claims the benefit of U.S. Provisional Patent Application No. 62/845,557, filed on May 9, 2019, entitled “UNSOLVED CASE FILE MYSTERY GAME,” which is incorporated by reference herein.

### FIELD

The present disclosure relates to a mystery-solving game and, more particularly, to a sequentially ordered gaming system, kit, and methods for solving a mystery.

### BACKGROUND

This section provides background information related to the present disclosure which is not necessarily prior art.

Murder mystery games have been around for some time, with the board game Clue perhaps being the most famous. Away from the board, other types of games involve the players assuming roles, typically with one of the players acting as the culprit. In most games, players are able to stumble upon the correct answer or make a guess that ends the game.

There is need in the art for a mystery game that provides a stimulating but orderly play to ensure that the players experience the full game without spoiling either the ending or the fun along the way.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a sequentially ordered gaming system that allows users to solve a mystery, which generally includes a first objective and a physical package with evidence that enables a user to complete the first objective. A first envelope or other enclosure comprises a second objective and additional evidence necessary for completion of the second objective, and a second enclosure comprises a third objective and additional evidence necessary for completion of the third objective. A remote confirmation source is accessed by the user to input specific evidence-related information to determine completion of the objectives. Completion of the first, second, and third objectives in order solves the mystery. The enclosures are typically physical enclosures that are sealed to keep their evidence concealed until use. A final enclosure tells the story of the solved mystery.

In one aspect, a remote source also provides hints that aid users in completing the objectives; however, a hint is not accessible until after the user has entered an answer that fails confirmation and completion of a related objective. The confirmation source instructs the user to open the first enclosure after confirmation of completion of the first objective and to open the second enclosure after confirmation of completion of the second objective. The sequence of solving the mystery typically alternates between physical evidence and electronic remote confirmation.

At the start of the game, players open a sealed evidence bag, which may be a heat-sealed plastic bag that holds the first objective and package of evidence. The evidence comprises photos, articles or other media, police files, maps, autopsy reports, victim profiles and personal information, person of interest reports, witness accounts, court orders, other physical or digital information, or a combination thereof.

In another embodiment, a kit that allows users to solve a mystery through a sequentially ordered gaming system is disclosed, which generally includes a sealed evidence bag that holds a first objective, a file folder comprising evidence that enables a user to complete the first objective, and instructions for the user to access a remote confirmation source to input specific evidence-related information to determine completion of the first and subsequent objectives, or to receive a hint. A sealed first enclosure comprises a second objective and additional evidence necessary for completion of the second objective, and a sealed second enclosure comprises a third objective and additional evidence necessary for completion of the third objective. Evidence for the kit is as described above.

In another embodiment, a method for using a sequentially ordered gaming system to solve a mystery is disclosed, which generally includes unsealing the evidence bag, reading a first objective, studying the available evidence, solving the first objective, and confirming the solution (optionally getting one or more hints). Then the user obtains the second objective with new evidence, which may require opening an enclosure like an envelope, and again studying the evidence to deduce and confirm a solution. These steps are repeated until a third and/or final objective is solved and confirmed, leading to a summary story of the adventure.

In another embodiment, a method of manufacturing the sequentially ordered gaming system for solving a mystery generally comprises providing the components for the system with the functionality for use as described above in the method of use.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

A more complete understanding of these embodiments, and the attendant advantages and features thereof, will be more readily understood by reference to the following detailed description when considered in conjunction with the accompanying drawings. The drawings described herein may not be to scale, are for illustrative purposes only of selected embodiments and not all possible implementations, and they are not intended to limit the scope of the present disclosure.

For clarity and in order to emphasize certain features, not all of the drawings depict all of the features that might be included with the depicted embodiment. The invention also encompasses embodiments that combine features illustrated in multiple different drawings; embodiments that omit, modify, or replace some of the features depicted; and embodiments that include features not illustrated in the drawings. Therefore, it should be understood that there is no restrictive one-to-one correspondence between any given embodiment of the invention and any of the drawings.

FIG. 1 illustrates an evidence bag and case file of a mystery game, according to some embodiments;

FIG. 2 illustrates sealed envelopes containing objectives and evidence, according to some embodiments;

FIG. 3 shows a chart that illustrates a sequentially ordered gaming system for solving a mystery, according to some embodiments;

FIG. 4 illustrates a remote source for confirming completion of objectives, according to some embodiments;

FIG. 5 illustrates evidence used to solve an objective of the mystery game, according to some embodiments;

FIG. 6 illustrates media-related evidence, according to some embodiments;

FIG. 7 illustrates victim-related evidence, according to some embodiments;

FIG. 8 illustrates maps and reference-related evidence, according to some embodiments;

and

FIG. 9 shows a flow chart that illustrates the method of the gaming system of FIG. 3, according to some embodiments.

Corresponding reference numerals indicate corresponding parts throughout.

### DETAILED DESCRIPTION

Any reference to “invention” within this document is a reference to an embodiment of a family of inventions, with no single embodiment including features that are necessarily included in all embodiments, unless otherwise stated. Furthermore, although there may be references to “advantages” provided by some embodiments, other embodiments may not include those same advantages, or may include different advantages. Any advantages described herein are not to be construed as limiting to any of the claims.

As used herein, relational terms, such as “first” and “second,” “top” and “bottom,” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

In describing preferred and alternate embodiments of the technology described herein, specific terminology is employed for the sake of clarity. The technology described herein, however, is not intended to be limited to the specific terminology so selected, and it is to be understood that each specific element includes all technical equivalents that operate in a similar manner to accomplish similar functions.

Example embodiments will now be described more fully with reference to the accompanying drawings. Specific details are set forth such as examples of specific components and methods to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known device structures are not described in detail.

In general, the embodiments provided herein relate to a mystery gaming system wherein players act as cold case detectives solving fictional cases that may resemble real-life unsolved crimes. The players study authentic materials as they complete a series of steps or goals that will lead them to the final solution. Each successful step is confirmed by an online answer key, which may further provide hints as needed, before proceeding to the next step. The mystery cannot be solved without completion of each step.

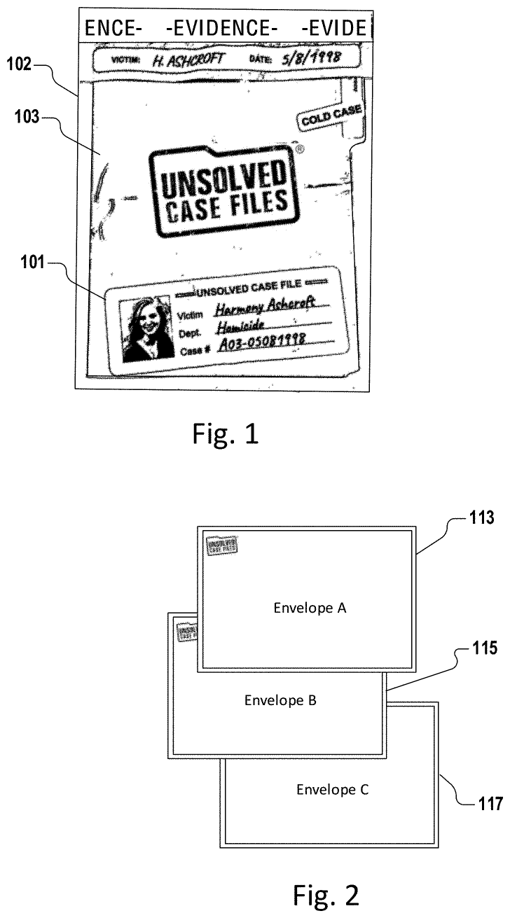

With reference to FIGS. 1-9, a sequentially ordered gaming system 100 or kit that allows users to solve a mystery comprises a case or mystery to be solved 101, an evidence bag 102 having a case file folder, box, or other physical package 103 that holds evidence 105, a series of objectives 112, 114, 116 to solve, and a remote confirmation source 120 for confirming achievement of those objectives and for solving the whole mystery 101. An emphasis is placed on components and evidence 105 that the players can feel and see in real life in order to build authenticity.

In a preferred embodiment, the evidence bag 102 is a clear, heat sealed plastic bag that signals the excitement that awaits. Once the evidence bag 102 is opened, it is resealable for convenience. The evidence bag 102 is not limited to this configuration, but may be adapted for suitable play. Evidence 105 comprises facts and other including, but not limited to, police and court files 106 (witness accounts, person of interest files, mugshots, fingerprints, legal documents, internal communications, etc.), articles and other media 107 (photographs, newspaper clippings, online videos, etc.), victim profiles and personal information 108 (life events, calendars, autopsy reports, etc.), references and maps 109, and other physical items and digital information (flash drives, security camera footage, audio recordings, accounting records, phone records, etc.) that would appear in an authentic crime investigation.

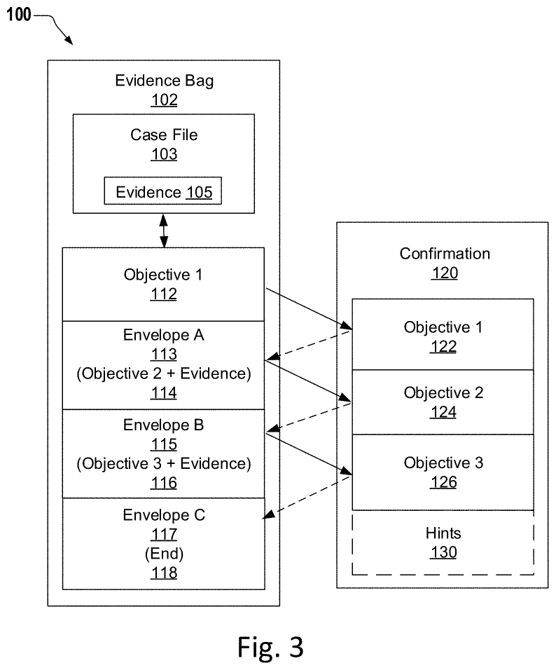

As shown in FIG. 3, the case file or physical package 103 includes Objective #1 or first objective 112 along with the evidence 105. Also included are at least two envelopes or other enclosures 113, 115 (see FIG. 2) containing Objective #2 or second objective 114 and Objective #3 or third objective 116, respectively. Each new objective 114, 116 is accompanied by new evidence 105 with plot twists. For example, the user may have to identify who is lying about their alibi in one objective, and the next objective may be to find the specific evidence that can be used to prove they committed the crime, if they did. Stated another way, a first enclosure 113 contains the second objective 114 plus new evidence, and a second enclosure 115 contains the third objective 116 plus more new evidence. Completion of the first, second, and third objectives 112, 114, 116 in order solves the mystery 101.

A third enclosure 117 may have a congratulatory note and a story 118 that summarizes the solved mystery. The gaming system 100 is not limited to two or three sets of instructions or steps, but may comprise any number of enclosures and objectives. The enclosures 113, 115, 117 may be releasably sealed, or preferably sealed in a manner that discourages opening prior to completion of the prerequisite objectives 112, 114, 116 in order to curtail spoilers and cheating. Alternately, objectives may be provided electronically, such as through an app or website.

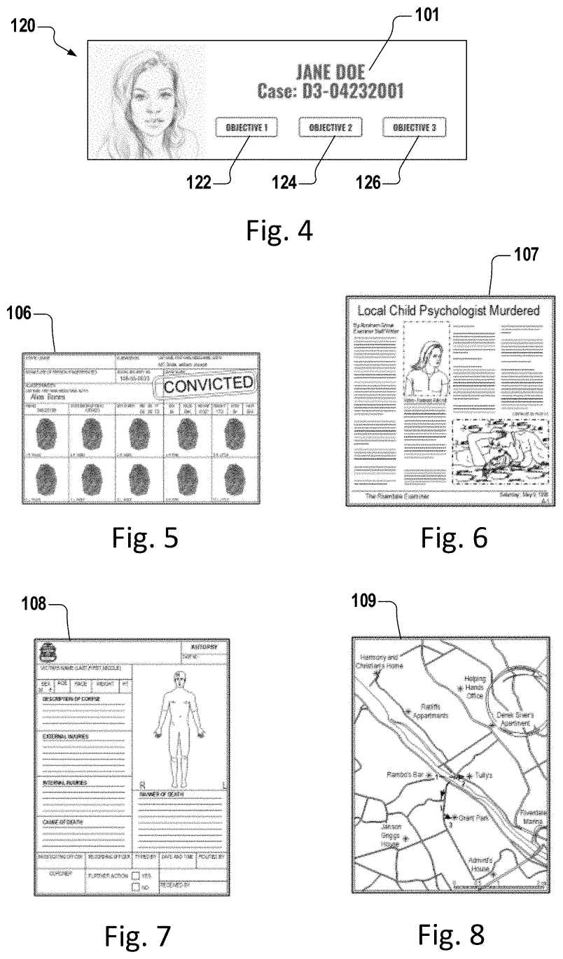

An answer key or confirmation source 120 (see FIG. 4) provides feedback to the players and controls the order in which the case is solved. Order creates a more enjoyable experience and rewards the players with incremental information and achievement. An electronic confirmation source 120 may be accessed via website, app, or phone, for example, although confirmation is not limited to electronic access. In a preferred embodiment, the user visits a website or app and clicks on the appropriate mystery 101 to bring up the confirmation source 120 display. There, the player will select the confirmation button 122, 124, 126 that corresponds to the current objective being solved (112, 114, or 116, respectively) and enter the requested answers or other information needed to verify. If incorrect, the player may request one hint 130. If incorrect multiple times, the available hints 130 are progressively more revealing. A hint 130 is not accessible until after the user has entered an answer that fails confirmation and completion of a related objective.

When a correct answer is given, the objective confirmation 122, 124, 126 is provided, and the player is instructed to go to the next step. Information for verification may include, but is not limited to, selecting key documents and locations of evidence on those documents, entering details (character names, locations, weapons, or other details), clicking on an image or map, combining correct elements with each other, optical character recognition, and virtual reality. Players are also presented with an easy way to share their progress on social media.

In a preferred embodiment that comprises physical enclosures 113, 115, 117 (holding objectives 112, 114, 116, respectively) and an electronic confirmation source 120, the sequence of solving the mystery 101 repeatedly alternates between physical evidence 105 and remote confirmation 120 (i.e., physical, electronic, physical, electronic, physical, electronic for a three-step cold case). A mystery 101 is not limited to this exact alternation, but may include interruptions of that basic pattern. Upon finishing the case, users may read a news article and/or see a lifelike TV news reporter telling the story of the case and how it was solved.

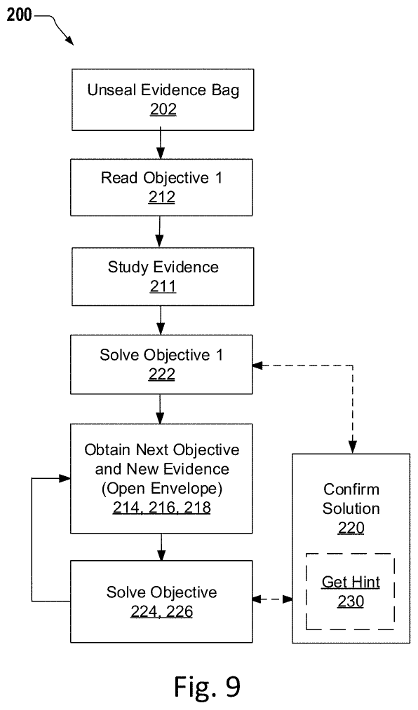

Turning to FIG. 9, in practice, to solve the mystery 200 the user unseals the evidence bag 202, reads a first objective 212, studies the available evidence 211, solves the objective 222, and confirms the first solution 220 (optionally getting one or more hints 230). Then the user obtains the second objective 214 with new evidence, which may require opening an enclosure 113 like an envelope, and again studies evidence to solve the second objective 224 and confirm a solution 220. These steps are repeated until a third and/or final objective 218 is solved 226 and confirmed 220, leading to a summary story 118 of the adventure.

A method of manufacturing the sequentially ordered gaming system 100 for solving a mystery 200 comprises providing the components in FIG. 3 with the functionality for use as charted in FIG. 9. One of skill in the art will understand that components and steps may be reordered, added, or omitted provided they achieve similar functionality to that which is described herein. Manufacturing may also lean toward kits and packages that are relatively “flat” for reduction of storage and shipping costs, although larger 3D components may be leveraged to enhance game play.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A sequentially ordered gaming system that allows users to solve a mystery, the gaming system comprising:
(a) a first objective;
(b) a physical package comprising evidence that enables a user to complete the first objective;
(c) a remote confirmation source accessed by the user to input specific evidence-related information to determine completion of the first objective;
(d) a first enclosure comprising a second objective and additional evidence necessary for completion of the second objective, wherein the remote confirmation source is accessed to determine completion of the second objective; and
(e) a second enclosure comprising a third objective and additional evidence necessary for completion of the third objective, wherein the remote confirmation source is accessed to determine completion of the third objective;
wherein completion of the first, second, and third objectives in order solves the mystery.

2. The gaming system of claim 1, wherein the first and second enclosures are physical enclosures that are sealed to keep their evidence concealed until use.

3. The gaming system of claim 1, further comprising a third enclosure comprising the story of the solved mystery.

4. The gaming system of claim 1, further comprising a remote source that provides hints that aid users in completing objectives.

5. The gaming system of claim 4, wherein the remote confirmation source provides hints.

6. The gaming system of claim 5, wherein a hint is not accessible until after the user has entered an answer that fails confirmation and completion of a related objective.

7. The gaming system of claim 1, wherein the confirmation source instructs the user to open the first enclosure after confirmation of completion of the first objective and to open the second enclosure after confirmation of completion of the second objective.

8. The gaming system of claim 1, further comprising a sealed evidence bag that holds the first objective and package of evidence.

9. The gaming system of claim 8, wherein the sealed evidence bag is a heat-sealed plastic evidence bag.

10. The gaming system of claim 1, wherein the evidence comprises photos, articles or other media, police files, maps, autopsy reports, victim profiles and personal information, person of interest reports, witness accounts, court orders, other physical or digital information, or a combination thereof.

11. The gaming system of claim 1, wherein the sequence of solving the mystery repeatedly alternates between physical evidence and electronic remote confirmation.

12. A sequentially ordered gaming system that allows users to solve a mystery, the gaming system comprising:
(a) a first objective;
(b) a physical package comprising evidence that enables a user to complete the first objective;
(c) a remote confirmation source accessed by the user to input specific evidence-related information to determine completion of the first objective or to receive a hint;
(d) a physical, sealed first enclosure comprising a second objective and additional evidence necessary for completion of the second objective, wherein the remote confirmation source is accessed to determine completion of the second objective or to receive a hint; and
(e) a physical, sealed second enclosure comprising a third objective and additional evidence necessary for completion of the third objective, wherein the remote confirmation source is accessed to determine completion of the third objective or to receive a hint;
wherein completion of the first, second, and third objectives in order solves the mystery.

13. The gaming system of claim 12, further comprising a third enclosure comprising the story of the solved mystery.

14. The gaming system of claim 12, wherein a hint is not accessible until after the user has entered an answer that fails confirmation and completion of a related objective.

15. The gaming system of claim 12, wherein the confirmation source instructs the user to open the first enclosure after confirmation of completion of the first objective and to open the second enclosure after confirmation of completion of the second objective.

16. The gaming system of claim 12, further comprising a sealed evidence bag that holds the first objective and package of evidence.

17. A kit that allows users to solve a mystery through a sequentially ordered gaming system, the kit comprising:
a sealed evidence bag comprising:
(a) a first objective;
(b) a file folder comprising evidence that enables a user to complete the first objective;
(c) instructions for the user to access a remote confirmation source to input specific evidence-related information to determine completion of the first objective or to receive a hint;
(d) a sealed first enclosure comprising a second objective and additional evidence necessary for completion of the second objective, wherein the remote confirmation source is accessed to determine completion of the second objective or to receive a hint; and
(e) a sealed second enclosure comprising a third objective and additional evidence necessary for completion of the third objective, wherein the remote confirmation source is accessed to determine completion of the third objective or to receive a hint;
wherein completion of the first, second, and third objectives in order solves the mystery.

18. The kit of claim 17, wherein the sealed evidence bag is a heat-sealed plastic evidence bag.

19. The kit of claim 17, wherein a hint is not accessible until after the user has entered an answer that fails confirmation and completion of a related objective.

20. The kit of claim 17, wherein the evidence comprises photos, articles or other media, police files, maps, autopsy reports, victim profiles and personal information, person of interest reports, witness accounts, court orders, other physical or digital information, or a combination thereof.
